(19) United States
(12) Patent Application Publication
(10) Pub. No.: US 2004/0189193 A1
(43) Pub. Date: Sep. 30, 2004

(54) Dial plate, a method for producing the dial plate, and an apparatus for producing the dial plate

(75) Inventors: Koji Ishii, Shizuoka (JP); Ichiro Kataoka, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 10/808,509

(22) Filed: Mar. 25, 2004

(30) Foreign Application Priority Data
Mar. 26, 2003 (JP) 2003-084429

(51) Int. Cl. H01J 1/62

(52) U.S. Cl. 313/506

(57) ABSTRACT

A dial plate for use in an instrument panel of a vehicle has laminated patterns of light emitting elements. The laminated patterns are formed on a substrate of the dial plate by laminating electroluminescent materials through printing. The laminated patterns have a specific design corresponding to external data.

### FIELD OF THE INVENTION

This invention relates to a dial plate of an instrument panel for a vehicle, a method for producing the dial plate, and an apparatus for producing the dial plate, and in more detail, to a dial plate for use in an instrument panel of a vehicle, and a method and an apparatus for producing said dial plate of the instrument panel.

### DESCRIPTION OF THE RELATED ART

Generally, an instrument panel for a vehicle, which displays measured value of such as a-vehicle speed or a rotational frequency of an engine, is mounted on a vehicle. This instrument panel for a vehicle includes a dial plate, on which indexes such as scale marks, numerals, texts, symbols, and the like are formed, a pointer being arranged in front of said dial plate, an inner machinery which drives said pointer corresponding to measured value, and a meter case which accommodates said dial plate, said pointer and said inner machinery.

The index of the dial plate described above is, for example, made by forming a design pattern corresponding to said index as an outline pattern with optical transparency on a black background with untransparency. Further, by transmitting light through the design pattern from a light bulb arranged in a meter case (at a back of the dial plate), the index is so illuminated brightly that a driver can see the index.

Each time when an arrangement of each displaying part, a shape, or a dimension of the dial plate is changed, for changing the design of the instrument panel for a vehicle, it is necessary to produce a new dial plate, and also produce other components of the instrument panel, such as a new frame member and a new substrate. Therefore, there is a problem that a production cost increases because of the design change of the dial plate.

To solve above described problem, a meter case of a conventional instrument panel for a vehicle is composed of a meter housing to house a meter drive, and a bulb housing arranged correspondingly to an indicator part, being able to house a plurality of bulbs. According to above structure, when the design of the displaying part is changed, for example, when changing the number or the arrangement of the indicator case is changed, the changing of the design is accomplished by only changing the number or the arrangement of the bulbs housed by the bulb housing of the meter case corresponding to the design, without changing the meter case (Patent Document 1).

[Patent document 1]

Japanese Patent Application Laid-Open No. Hei 6-122333 (Page 2 to 3, FIG. 1)

However, the conventional instrument panel as described in Patent Document 1 cannot solve a problem that an unusually troublesome work of changing the arrangement of bulbs is needed when changing the design of the dial plate, though it is possible to commoditize some components. Further, there is a problem that a range of the design change is regulated by a variation of the bulb arrangement. Further, when the dial plate is produced by screen-printing or the like, each design needs each printing plate. Therefore, it is difficult to decrease a production cost accompanying the design change of the dial plate.

This invention has been accomplished to solve the above described problems and an object of this invention is to provide a dial plate of an instrument panel for a vehicle, a method for producing the dial plate, and an apparatus for producing the dial plate, said dial plate being able to be changed easily corresponding to a design change of the dial plate.

### SUMMARY OF THE INVENTION

In order to attain the object, according to this invention, there is provided a dial plate for use in an instrument panel of a vehicle comprising laminated patterns of light emitting elements, said laminated patterns being formed on a substrate of the dial plate by laminating electroluminescent materials through printing, and having a specific design corresponding to external data. Preferably, according to this invention, there is provided the dial plate for use in an instrument panel of a vehicle as described above, wherein a wiring pattern for supplying electric power to the light emitting elements is formed on the substrate as a part of the laminated patterns through printing. Further, according to this invention, there is provided a method for producing a dial plate for use in an instrument panel of a vehicle comprising the steps of: receiving external data; forming laminated patterns on a substrate of the dial plate by laminating electroluminescent materials through printing, whereby said laminated patterns has a specific design corresponding to the external data.

Further, according to this invention, there is provided an apparatus for producing a dial plate for use in an instrument panel of a vehicle comprising: a printing head of which nozzle is able to eject fluid; a transporting means to transport the printing head to a specific position; a receiving means to receive external data; and a controlling means to control motion of the transporting means and ejection of respective electroluminescent materials from the printing head in order to form laminated patterns of light emitting elements on a substrate of the dial plate, whereby said laminated patterns has a specific design corresponding to the external data.

According to above dial plate and above apparatus for producing the dial plate, laminated patterns are formed in a light emitting display area on a substrate of the dial plate of the instrument panel having a specific design corresponding to external data with electroluminescent materials through an inkjet printer. Therefore, only by generating external data corresponding to a design change of the dial plate, the dial plate with the design can be produced. Further, since the light emitting display area is produced as laminated patterns of light emitting element by laminating electroluminescent materials through printing, an operation to arrange bulbs at backside of the dial plate can be eliminated even at design change. Therefore, since only changing the external data can change the dial plate design, it is easy for production of the dial plate to cope with the design change, and it is also easy to cope with limited production of diversified products.

According to this invention, the wiring pattern for supplying electric power to the electroluminescent device is formed on the substrate of the dial plate by printing. Therefore, a glass or synthetic resin substrate can be used as a wiring substrate, and it become unnecessary to produce a conventional wiring substrate, so that production cost of the dial plate can be reduced.

According to this invention, after the receiving means receives the external data, the control means controls the motion of the transporting means and ejection of the respective materials from the printing head to form the laminated patterns with the electroluminescent materials corresponding to the external data. Therefore, since only changing the external data can change the dial plate design, it is easy for the apparatus for producing the dial plate to cope with the design change, also easy to cope with limited production of diversified products.

### BRIEF DESCRIPTION OF THE DRAWINGS

FIG. 1 is a front view of a dial plate of an instrument panel according to this invention;

FIG. 2 is a schematic view showing one embodiment of an apparatus for producing the dial plate according to this invention;

FIGS. 3A to 3D are sectional views of the dial plate shown in FIG. 1;

FIGS. 4A to 4F are sectional views showing another embodiment of the dial plate of this invention; and

FIGS. 5A to 5B are views showing another embodiment of a design of the dial plate.

### DESCRIPTION OF THE PREFERRED EMBODIMENT

One embodiment of an apparatus for producing the dial plate according to this invention will now be described with reference to the attached drawings.

FIG. 1 shows a dial plate 1 for use in an instrument panel of a vehicle (hereinafter referred to as “dial plate”). The dial plate 1 has a segment display area 10a including indexes, such as scales, numerals and texts, used for a speedometer S, a tachometer T, a warning W, a turn signal TS and the like, and a dot matrix display area 10b used for a car navigation system, a rear view camera system, and the like. The segment display area 10a and the dot matrix display area 10b are components of the light emitting display areas 10.

In the light emitting display areas 10 on a substrate 11 of a dial plate 1, the laminated patterns are printed corresponding to the external data with the electroluminescent materials of the electroluminescent element (hereinafter referred to as “EL element”). This substrate 11 is made of glass, synthetic resin or the like. A through hole 11a is formed at vicinity of a center of each display area of the speedometer S and the tachometer T on the substrate 11. An output shaft (not shown) penetrates the through hole 11a. A pointer 20 provided in front of the dial plate 1 is rotated on the output shaft. An inner machinery (not shown) is provided at a back of the dial plate 1 to rotate the pointer 20 according to measured value.

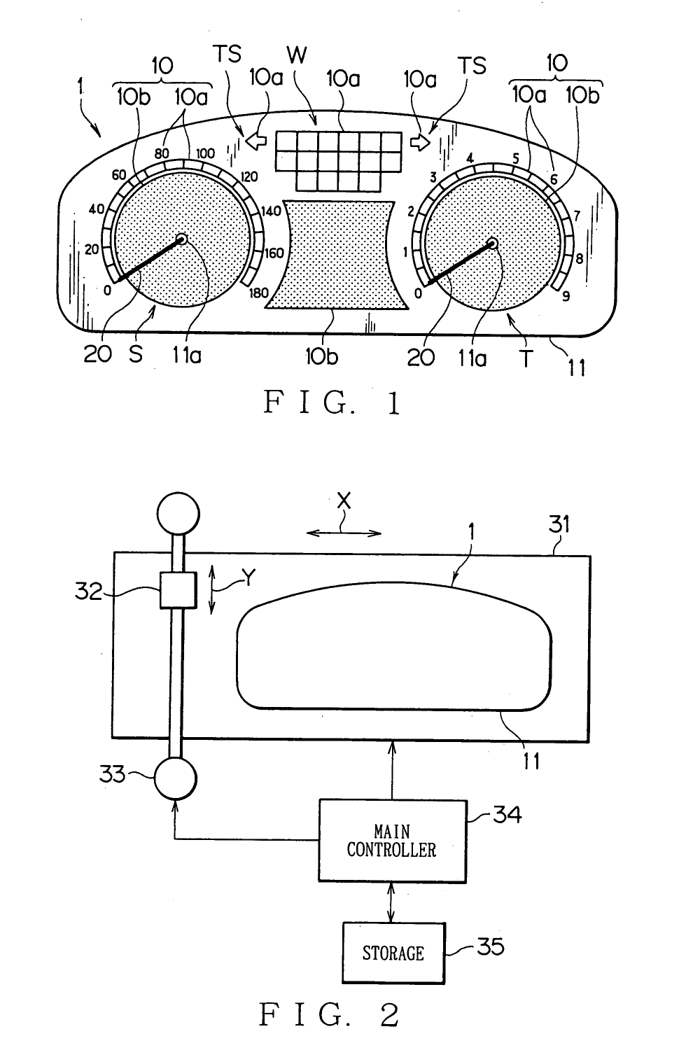

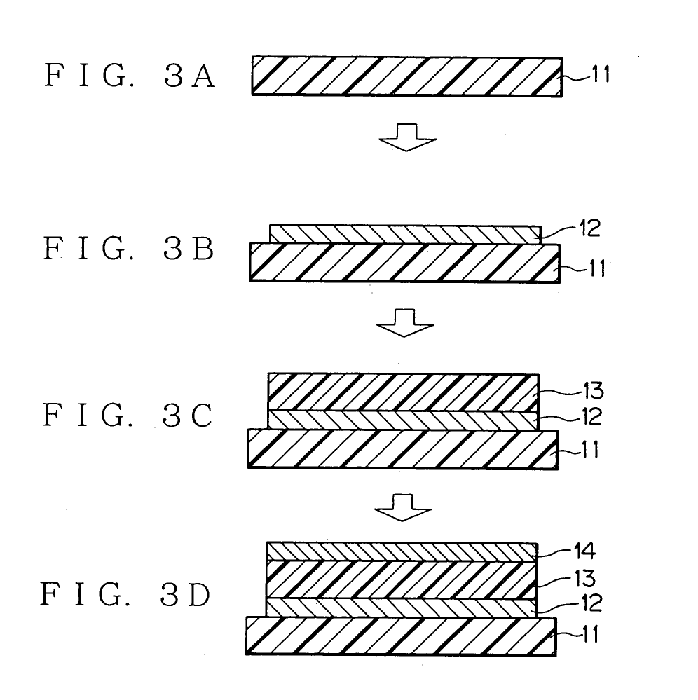

As shown in FIGS. 3A to 3D, an apparatus 30 for producing the dial plate 1 comprises a stage 31, on which the substrate 11 of the dial plate 1 as a printing medium is chucked, said stage 31 being movable in x direction of FIG. 2; a printing head 32, of which ejector-ejects fluid to the medium; a head controller 33 to control both movement in y direction of FIG. 2 and fluid ejection from the printing head 32; a main controller 34 to control both the stage 31 and the head controller 33; and a storage 35 to store various data such as the external data of a specific pattern being printed in the light emitting display area 10 on the substrate 11.

As commonly known, the ejector of the printing head 32 ejects fluid by such as stress generated by deformation of a piezoelectric transducer to which voltage is applied, or pressure from a bubble generated in fluid being heated by an electothermal converter. The fluid as electroluminescent material is supplied through a tube or the like.

For producing the dial plate 1, the main controller 34 receives the external data from such as a data terminal on a network or a terminal connected to a main server, and sends the external data to the storage 35. Then, the main controller 34 controls the stage 31 and the head controller 33 to transport the printing head 32 to the specific position and controls the ejection of the material from the printing head 32.

Therefore, in this embodiment, a combination of the stage 31 and the head controller 33 works as the transporting means in claims. The main controller 34 works as the controlling means in claims. In addition, a composition of the apparatus 30 is not limited to the composition described above, for example, a stage being movable in both x and y direction in FIG. 2 is applicable to the stage 31, and a controller to control a transportation of the printing head 32 to the specific position is applicable to the main controller 34. According to above, there can be various types of apparatuses as embodiments of this invention.

The external data stored in the storage 35 indicates laminated patterns to print with the electroluminescent materials on the substrate 11 of the dial plate 1. One example of the external data has data for indicating a model number of the dial plate 1, data for identifying one material to be used among materials of EL element corresponding to a specific layer, a pattern data of a pattern corresponding to the specific layer to be printed, in a data structure indicating which layer is to be printed next.

Further, by using software to generate the external data directly from a design designed by a user, such as a car driver or a worker of a car maker, the apparatus 30 can easily produce a custom-designed dial plate 1.

As shown in FIGS. 3A to 3D, a process flow of printing a design pattern shown in FIG. 1, using the apparatus 30, will be explained. Explanations of printing processes for other optional patterns are omitted.

Firstly, after the substrate 11 is loaded on the stage 31, and the pattern to be printed on the substrate 11 is selected by such as an operator, the apparatus 30 starts receiving the external data corresponding to the pattern to store the external data in the storage 35. Secondly, the apparatus 30 extracts data indicating one of electroluminescent materials to be printed firstly and data of the pattern from the external data. Thirdly, the apparatus 30 moves the printing head 32 to positions indicated by the pattern data sequentially, then, at each position, controls the printing head 32 to eject fluid of material of wiring metal such as aluminum to the substrate 11. Thus, as shown in FIG. 3B, a metal electrode 12, as an anode for example, is printed on the substrate 11.

Fourthly, corresponding to the external data, the printing head 32 is moved to positions designated by the next pattern sequentially, then at each position, the printing head 32 ejects next material, which is such as pi conjugate polymer system, pigment polymer (non-conjugate) system, or the like to the substrate 11. Thus, as shown in FIG. 3C, an emitting layer 13 is printed on the metal electrode 12.

According to the material used in the emitting layer 13, an emission color of the emitting layer 13 is determined. Therefore, the patterns with respective emission colors corresponding to the external data can be printed by changing the materials to be ejected.

Finally, after extracting the last material identifying data and the last pattern data from the external data, the apparatus 30 moves the printing head 32 to positions indicated by the last pattern data and controls the printing head 32 to eject material such as ITO (Indium Tin Oxide) to the substrate 11 according to the last material identifying data at respective positions sequentially. Thus, a transparent electrode 14, as a cathode for example, is formed on the emitting layer 13. Then, a passivation layer, for covering a surface of the transparent electrode 14 and other areas, is formed by such as fluid of overcoat material to prevent electrodes from being oxidized and prevent EL devices from being damaged.

Thus, the apparatus 30 produces an EL element as laminated patterns having the specific design shown in FIG. 1, by printing the patterns corresponding to the external data on the substrate 11 of the dial plate 1.

Further, the external data in this embodiment includes a wiring pattern for supplying electric power to the EL device, so that the apparatus 30 can print the not shown wiring pattern on the substrate 11 corresponding to the external data.

The dial plate 1 produced by the apparatus 30 is assembled into the instrument panel to be mounted on a vehicle. When the panel lights up, by supplying electric power from the vehicle to the EL element of the dial plate 1 through the wiring pattern, electron is injected from the transparent electrode 14 to the emitting layer 13, while hole is injected from the metal electrode 12 to the emitting layer 13, so that the emitting layer 13 emits by recombination of the electron and the hole. Then, the emission through the transparent electrode 14 of the light emitting display areas 10 is recognized by a vehicle driver.

As shown in FIG. 1, a display controller of the instrument panel controls each segment display area 10a of the speedometer S, and the tachometer T to emit according to measured data, and each segment display area 10a of a warning W, and a turn signal TS to emit respectively when an event corresponding to said W or TS happens. Further, the display controller controls the dot matrix display area 10b of such as a car navigation system to display an information according to the car driver's choice.

According to above, since this apparatus 30 can produce the dial plate 1 of the specific design only by changing the external data, this apparatus 30 can easily cope with the design change of the dial plate 1, and the limited production of diversified products.

Further, since the wiring pattern for supplying electric power to the EL device is printed on the substrate 11, a substrate made of glass, synthetic resin or the like can be used as the substrate 11, so that a wiring board as the substrate 11 is not necessary for producing the dial plate 1, and production cost can be reduced.

Next, another embodiment of the light emitting display areas 10 will be explained below.

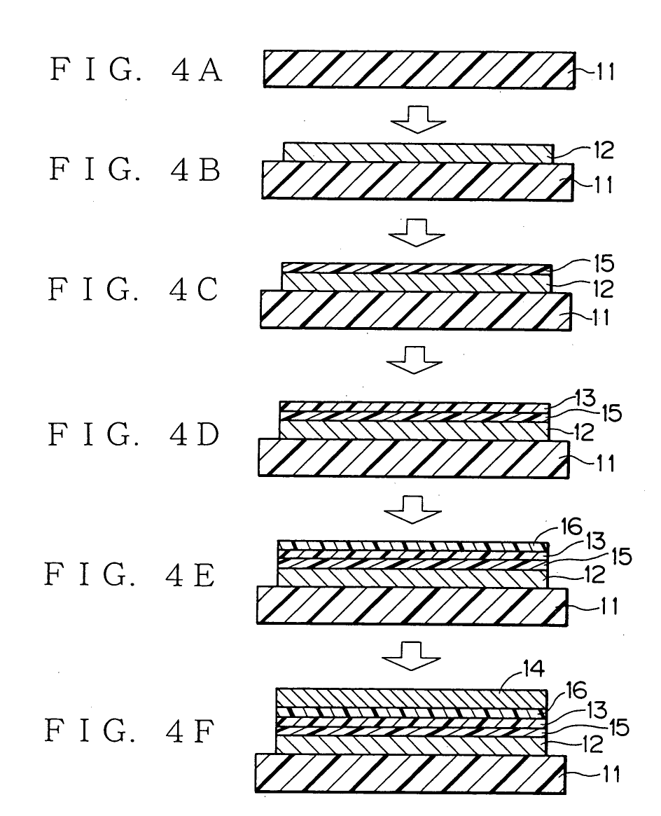

After the substrate 11 shown in FIG. 4A is loaded on the stage 31, the apparatus 30 prints the pattern corresponding to the external data of the metal electrode 12 shown in FIG. 4B, then prints a hole ejection layer 15 shown in FIG. 4C. The hole injection layer is made of such as polyaniline and organic acid, or polythiophene and polymer acid to allow the hole to penetrate into the hole injection layer smoothly from the metal electrode 12.

As shown in FIG. 4D, the emitting layer 13 is printed on the hole ejection layer 15, then an electron injection layer 16 shown in FIG. 4E is printed on the emitting layer 13, then the transparent electrode 14 shown in FIG. 4F is printed on the electron injection layer 16. The electron injection layer 16 is made of such as Barium or Calcium to allow electron to penetrate into the electron injection layer 16 smoothly from the transparent electrode 14.

When the instrument panel lights up, by supplying electric power from the vehicle to the EL element of the dial plate 1 through the wiring pattern, electron is injected from the transparent electrode 14 to the emitting layer 13 through electron injection layer 16, while hole is injected from the metal electrode 12 to the emitting layer 13 through hole ejection layer 15, so that the emitting layer 13 emits by recombination of the electron and the hole. Then, the emission of the light emitting display areas 10 is recognized by a vehicle driver. Thus, this embodiment has the same effect as the first embodiment. Therefore, various electroluminescent materials can be used in the light emitting display areas 10.

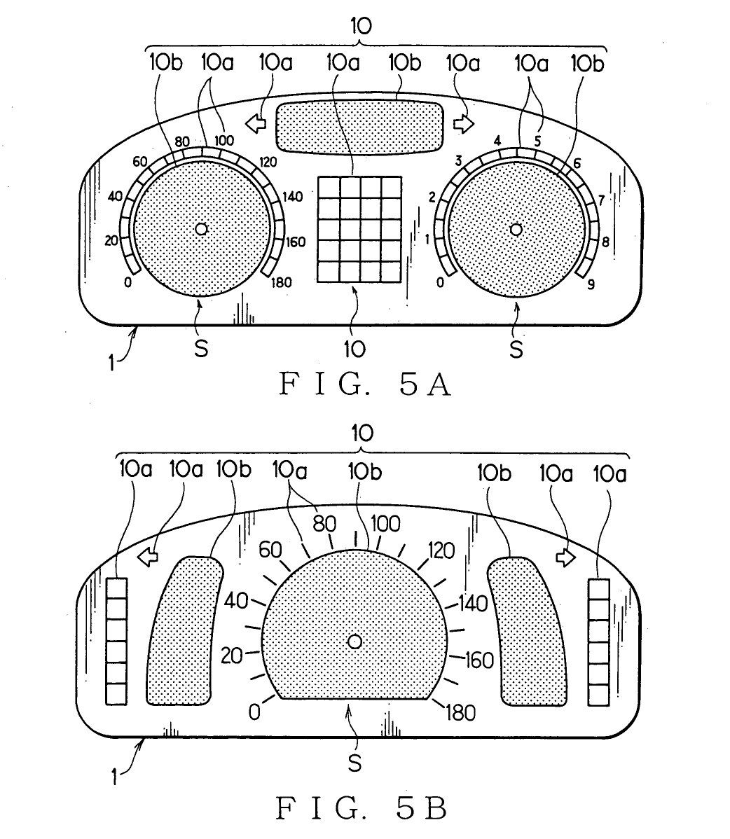

As shown in FIGS. 5A and 5B, the external data described above is generated corresponding to the design of the dial plate 1. One embodiment of a method of producing sequentially the dial plates of different designs according to these data will be explained below.

FIG. 5A shows the dial plate ion which pointers are attached to the speedometer and the tachometer, and FIG. 5B shows the dial plate 1 on which the pointer is attached only to the speedometer.

Firstly, after receiving the two external data, the apparatus 30 controls the stage 31 and the head controller 33 to print the pattern according to one of the two external data on the substrate 11 as shown in FIG. 5A. Then, after the next substrate 11 is loaded on the stage 31, the apparatus 30 controls the stage 31 and the head controller 33 to print the pattern according to the other external data on the substrate 11 as shown in FIG. 5B.

Thus, the apparatus 30 of this invention can easily produce a plurality of dial plates 1 with different designs only by receiving a plurality of external data corresponding to said designs. Therefore, as compared to conventional apparatus which needs to change screen printing plates when the design is changed, this apparatus 30 can cope with the limited production of diversified products and reduce the production cost of the dial plate 1.

Moreover, in above described embodiments, one printing head 32 prints all layers of the EL element, but this invention is not limited to this. A plurality of printing head 32 for respective electroluminescent materials may print laminated patterns, or a plurality of apparatuses 30 for respective electroluminescent materials may print laminated patterns on the substrate 11, said substrate 11 is moved to the apparatuses 30 sequentially by such as a belt conveyer.

As described above, the electroluminescent materials of this description include metallic material and metal complex material.

What is claimed is:

1. A dial plate for use in an instrument panel of a vehicle comprising laminated patterns of light emitting elements, said laminated patterns being formed on a substrate of the dial plate by laminating electroluminescent materials through printing, and having a specific design corresponding to external data.

2. The dial plate for use in an instrument panel of a vehicle as claimed in claim 1,
wherein a wiring pattern for supplying electric power to the light emitting elements is formed on the substrate as a part of the laminated patterns through printing.

3. A method for producing a dial plate for use in an instrument panel of a vehicle comprising the steps of:
receiving external data;
forming laminated patterns on a substrate of the dial plate by laminating electroluminescent materials through printing,
whereby said laminated patterns has a specific design corresponding to the external data.

4. An apparatus for producing a dial plate for use in an instrument panel of a vehicle comprising:
a printing head of which nozzle is able to eject fluid;
a transporting means to transport the printing head to a specific position;
a receiving means to receive external data; and
a controlling means to control motion of the transporting means and ejection of respective electroluminescent materials from the printing head in order to form laminated patterns of light emitting elements on a substrate of the dial plate,
whereby said laminated patterns has a specific design corresponding to the external data.
